(19) United States
(12) Patent Application Publication
(10) Pub. No.: US 2026/0187203 A1
(43) Pub. Date: Jul. 2, 2026

(54) METHOD AND SYSTEM FOR AUTHENTICATING TAGS DURING SALES OF PHYSICAL ITEMS

(71) Applicant: NAGRAVISION SÀRL, Cheseaux-sur-Lausanne (CH)

(72) Inventors: Juan-Ramon HERNANDEZ, Cheseaux-sur-Lausanne (CH); Joel CONUS, Cheseaux-sur-Lausanne (CH); Marie-Pascale GAZEAU, Cheseaux-sur-Lausanne (CH)

(73) Assignee: NAGRAVISION SÀRL, Cheseaux-sur-Lausanne (CH)

(21) Appl. No.: 19/006,896

(22) Filed: Dec. 31, 2024

(51) Int. Cl. G06F 21/10; G06K 19/06; G06Q 30/018

(52) U.S. Cl. CPC G06F 21/108; G06K 19/06037; G06Q 30/0185

(57) ABSTRACT

A method, system, processing circuitry, and computer program product using tags associated with the items being sold that are readable by mobile devices of participants to the transfer. The tags include at least one of an asymmetric key and a shared symmetric key for signing responses indicating that the tag is in the presence of the transferrer.

### BACKGROUND OF THE INVENTION

### Field of the Invention

This disclosure relates to a method, system, processing circuitry, and computer program product using real-time verification of the authenticity of physical items being transferred, and, in one embodiment, to a method, system, processing circuitry, and computer program product using tags associated with the items being transferred that are readable by mobile devices of participants to the transfer.

### Discussion of the Background

During the transfer (e.g., sale or rental) of expensive items, the buyer (i.e., the receiver of the items) has a vested interest in ensuring that the items being transferred are authentic. However, as counterfeit items become more sophisticated, the ability to detect counterfeits is becoming increasingly difficult. The original manufacturers of legitimate items have a vested interest in ensuring that only the items of the quality and quantity desired of the manufacturer are released to the market. For example, the exclusivity of some items helps to keep prices elevated as compared to the price of the items if they were readily available to all potential customers.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic illustration of an interaction of a buyer and seller when transferring ownership of an item containing a cryptographic tag;

FIG. 2 is a schematic illustration of a transaction transferring an item between a remote seller and buyer according to one aspect of the disclosure;

FIG. 3 is a schematic illustration of a transaction transferring an item between a co-located seller and buyer according to one aspect of the disclosure;

FIG. 4 is a table showing records of a database for tracking manufacturers and sellers/buyers as described herein;

FIG. 5 is a table showing records of a database for tracking tagged items as described herein;

FIG. 6A is a table showing records of a database for tracking ownership of items before item 123 is transferred between a seller (P777) and a buyer (P888) as described herein;

FIG. 6B is a table showing records of a database for tracking ownership of items after item 123 is transferred between a seller (P777) and a buyer (P888) as described herein;

FIG. 6C is a table showing records of a database for tracking ownership of items after item 123 is transferred between a seller (P888) and a buyer (P999) as described herein; and

FIG. 7 is a table showing a record of a database for tracking advertisements of items as described herein.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

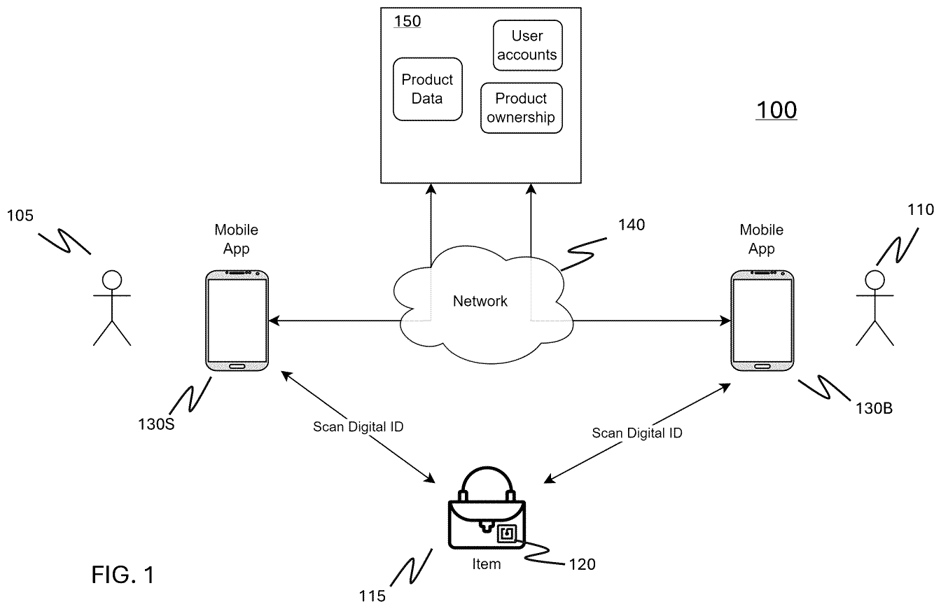

As shown in FIG. 1, as part of an authentication system 100, a seller 105 may interact with a buyer 110 when transferring a right of an item 115 associated with a cryptographic tag 120. As used herein, a seller 105 generally refers to a conventional seller but also to a lessor. Similarly, a buyer 110 herein refers to a conventional buyer but also to a lessee. Accordingly, when transferring a right to the item between a seller and buyer, the right may be an ownership right or possession for a period of time under a lease.

Thus, examples of transfers between seller 105 and buyer 110 will be provided below in the context of a sale of the item between a seller 105 and a buyer 110 without limiting the disclosure thereto. As noted above, the transfer instead can be a temporary transfer such as may occur when an item is rented or leased.

In one embodiment, the cryptographic tag 120 is physically attached to item 115 in a manner that would damage the item 115 should the tag 120 be removed. In one embodiment, the tag 120 is adhered (e.g., glued) or sewn internally to the item 115. As shown in FIG. 1, the seller 105 and the buyer 110 each has an associated computing device 130S and 130B, respectively. The computing devices 130S and 130B may be mobile telephones equipped with at least one of a near field communications device, a camera, and a Bluetooth adapter. The interactions between the seller and buyer are facilitated by communications (e.g., IP-based connections over at least one network 140) between the computing devices with the mediation of the server system 150. Networks 140 include, but are not limited to, WiFi networks (e.g., using any of the families of protocols under the 802 standards) or mobile phone-based communications (e.g., using 3G, 4G, or 5G protocols). The computing devices 130S and 130B interact with at least one backend server system 150 which, as described in greater detail below, contains at least one data repository (e.g., a database or blockchain) including information that facilitates the transfer (e.g., product data, user accounts, and product rights information such as ownership or lease information).

As part of the authentication process used by a manufacturer of items to be authenticated by the processes described herein, tags are produced which can be associated with items of the manufacturer. Prior to shipment to customers, at least one of the manufacturer's tags is attached to an item to be distributed (e.g., sold or leased) to a customer, wherein a key is associated with tag. In one embodiment, the key is written to the tag by the manufacturer of the item, and, in another embodiment, the key is pre-loaded into the tag by the distributor of the tag. The tag is programmed to include a unique identifier of the tag that is associated with the item to be transferred. In one embodiment, the information on the tag and its associated item (e.g., a description of the item such a handbag of style1 by manufacturer2) is sent to the backend server system 150 at the time that the tag is associated with the item. In an alternative embodiment, the information may be transferred to backend server system 150 at a later time (e.g., upon a first use by a seller 105 as described below). One such record of a database for tracking such information is shown in FIG. 5.

In one embodiment, prior to a customer receiving any items that are associated with the tags described herein, the customer registers with the backend server system 150, for example, by providing the customer's identifying information using a computer program (e.g., an “app”) on the customer's computing device. Information is shown in FIG. 5 for a set of fictious people (having unique user IDs (UUIDs) starting with “P”) and a manufacturer (having a UUID indicates as “Mfctr1”).

A portion of the information may be publicly provided information as part of future transactions (e.g., a name or ID of the customer), and some of the information may be private (e.g., a customer's address that could be used to return lost or stolen items associated with the customer by registered tags). The app associated with the customer's computing device may include additional information (e.g., a unique ID for the computing device) that the app uses to identify itself to the backend server system 150. The app can dynamically receive or permanently store information (e.g., a user id and password and any two-factor information) that the customer uses to identify itself to the backend server system 150.

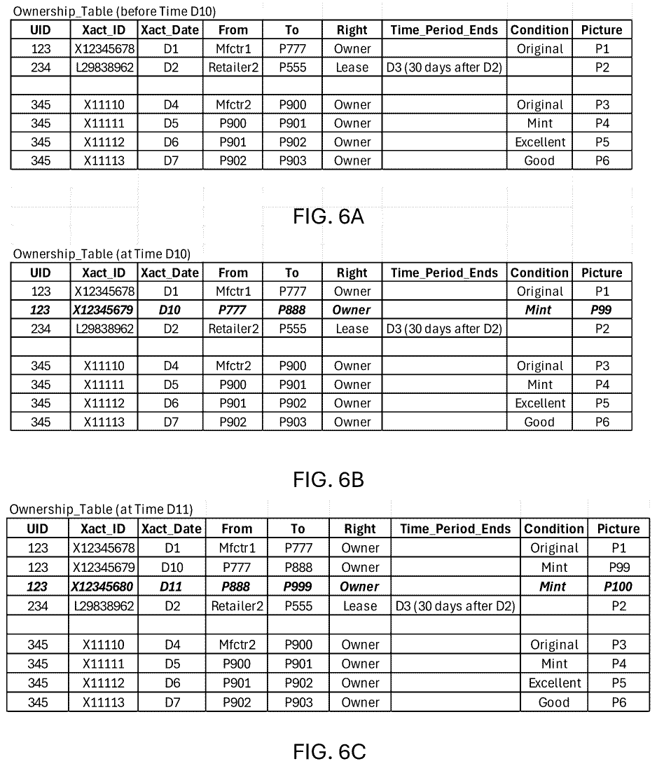

In one embodiment, at the time of a first transfer (e.g., sale or lease) of an item (e.g., item “123” shown in FIG. 5), the potential receiver of the item (e.g., the first buyer or lessee) (e.g., the person having UUID=P777) authenticates itself (e.g., using the app) to the backend server system 150 and scans (e.g., using near field communication) the tag of the item using the potential receiver's computing device. Information from the tag is sent to the backend server system 150 which can authenticate the tag and send to the potential receiver (UUID=P777) authenticity and ownership certificates. Such a procedure would generally occur at a trusted retailer (e.g., an authorized distributor of the item) (e.g., a retailer selling on behalf of “Mfctr1”). Upon purchase (or other transfer of the item), the retailer would then be able to utilize its own computer system to indicate that the item has been transferred to the potential receiver as shown in FIG. 6 in the record corresponding to Xact_ID=X12345678.

If the item was not earlier registered with the backend server system 150 at the time that the potential receiver scans the tag, the backend server system 150 may interact with the manufacturer purported to have created the item (e.g., using information contained in the scanning of the tag), and the backend server system 150 and the manufacturer may exchange necessary information if the item is, in fact, authentic. Such a method may avoid the backend server system 150 storing information on items that will never be registered with the backend server system 150.

As part of the receipt of the item, the backend server system 150 stores that the right (e.g., ownership) to the item has been transferred to the receiver, and the app of the receiver may receive confirmation of the transfer that can be displayed to the receiver. The backend server system 150 optionally may store additional information about the transfer (e.g., an amount of time that the item is to be transferred in the case of a rental or lease, the amount paid for the item, a picture of the receiving party or the item at the time of the transfer).

At a later time, the receiver (UUID=P777) can use the app of the receiver to transfer the item to another party or indicate that the item has been lost or stolen (as have items with UID=567 and UID=678 in FIG. 5). In the latter case, the app may inform the backend server system 150 of any information that can be shared in case the item is later scanned as part of either (a) an attempt to fraudulently transfer the lost/stolen item or (b) at a police department when the item is turned after it has been found).

In any of the interactions with the backend server system 150 described herein, the backend server system 150 can authenticate the tag using one or more authentication credentials. Such authentication credentials include, but are not limited to, a symmetric key (Key_Type=“S” in FIG. 5) and an asymmetric key (Key_Type=“A” in FIG. 5). In the case of a symmetric key, the backend server system 150 utilizes a symmetric key (e.g., Key=S1) known only to the tag and the backend. In one such embodiment, the tag generates a message and a corresponding message authentication code (a MAC) based on the shared key. The message and MAC are read by the app of the customer scanning the tag, and the message and MAC are forwarded by the app to the backend server system 150. The backend server system 150 verifies that the MAC corresponds to the received message based on the shared key and accepts the tag as authentic if the MAC corresponds to the received message based on the shared key.

Alternatively, the backend server system may utilize a challenge-response protocol in which the backend server system 150 sends a challenge to the app of the scanning customer using the network 140. The app of the customer forwards the challenge to the tag (e.g., using near field communication), and the tag replies to the app with a MAC of the challenge. The app then forwards the MAC to the backend server system 150 which verifies the reply. If the reply is verified, the tag is authenticated.

In an embodiment in which an asymmetric key is used (e.g., for UID=234 in FIG. 5), the private key is known only to the tag, and the backend server system 150 utilizes a chain of digital certificates (known as a “chain of trust”) attesting that the corresponding public key (e.g., A1) belongs to a genuine tag. In such a configuration, the backend server system 150 sends a challenge to tag (through the app of the customer scanning the tag). The tag replies with a signature of the challenge generated with the private key of the tag, and the reply is forwarded from the tag (through the user's app) to the backend server system 150 which verifies the signature with the public key. It also is possible for the app to send challenges to the tag directly and communicate the results of the challenge to the backend server system 150.

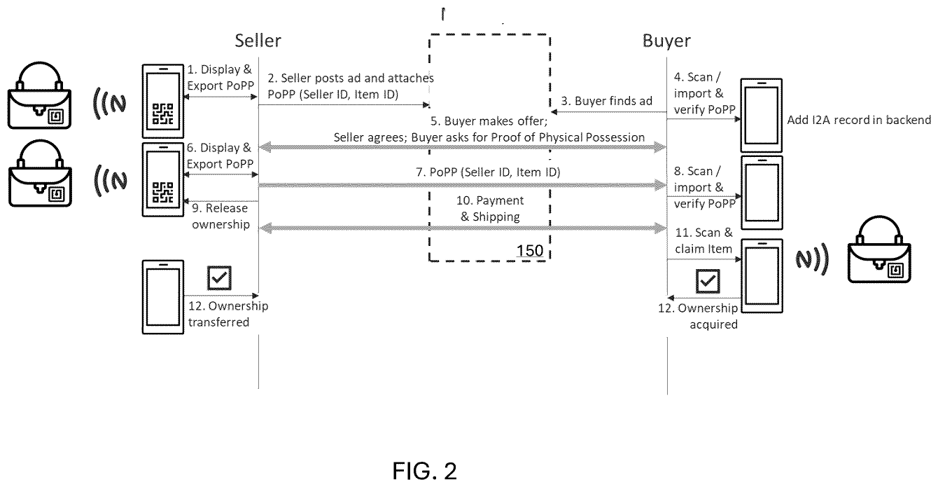

Turning to FIG. 2, a previously registered item (e.g., UID=123) may be transferred from an existing owner (e.g., UUID=P777) (e.g., acting as a seller or lessor) to a potential recipient (e.g., P888) (e.g., acting as a buyer or a lessee). Alternatively, the item need not have been previously registered with the backend server system 150, and the first interaction with the backend server system 150 may be during a party-to-party transfer.

In step 1, the seller utilizes an app on its computing device to scan (e.g., using near field communication) the tag of the item that is physically in the presence of the owner. The app optionally may send as part of the scanning request a non-repeating value (e.g., the current time) to ensure that the result is not stored and replayed later.

In response to the scan, the tag generates, using an authentication credential stored therein, a response (e.g., a MAC) that the tag uses to prove the authenticity of the item and that the owner has physical possession of the item. In step 2, the app then sends to the backend server system 150 (acting as a marketplace) a first notification of the item to be transferred, wherein the first notification includes a unique identifier of the item and the information generated by the tag when scanned. The notification may further include additional information (e.g., a picture of the item, a seller ID of the seller, a time that the notification was generated, a price (or minimum price) at which the seller is selling the item, and/or a time period in which the item will be offered for transfer). In one embodiment, the backend server system 150 can utilize the information in the first notification to authenticate that the item is authentic (e.g., using the shared or asymmetric keys) before creating a posting (e.g., an advertisement) related to the fact that the seller wishes to sell the item. Server 150 can then generate a “cryptographic posting”, a digitally-signed certificate containing the information described herein. Seller can then post this certificate to a marketplace where seller posts an advertisement or a listing. Data for creating such an advertisement for the item with UID=123 is shown in FIG. 7 and may include a link to the advertisement (stored in field Ad_ID). By utilizing the link, the UID of the item is not directly exposed within the advertisement. This also prevents man-in-the middle attacks in which a rogue seller could advertise the same product by copying the “cryptographic posting” generated by the app as per the legitimate seller's request. The link of the genuine ad/listing in the marketplace, or the legitimate seller's user ID in that marketplace can be included in the “cryptographic posting”. This information can then be checked by the buyer, or the buyer's app could also re-direct the buyer to the genuine ad/listing based on the ad URL. Alternatively, the UID of the item can be included in the advertisement.

The marketplace also can be a passive marketplace that does not check the information at the time that the posting is made, instead relying on the app of the buyer to confirm the authenticity information. The advertisement may include additional information about the item, and, in one embodiment, the advertisement includes at least one hyperlink for providing potential buyers with additional information about the item.

One such advertisement includes information on the item, the sale parameters for the item (e.g., item description and picture showing the condition of the item), and the authenticity information generated by the tag. In one embodiment, the posting includes a QR code that enables a user's app to contact the backend server system 150 to begin the process of checking the authenticity of the item.

In step 3, a potential buyer browsing the marketplace (or that has established trigger criteria for being informed of items which interest the potential buyer) eventually determines that an item exists that the potential buyer would like to purchase/lease. In step 4, the potential buyer can then (through its app) obtain (e.g., by scanning a QR code contained within the advertisement) the information needed to contact the backend server system 150 to begin the authentication and transfer process. As part of that process, an intent-to-acquire record (I2A) can be generated on behalf of the potential buyer. The I2A record indicates the buyer's interest in acquiring the item. This allows backend to know what user ID (app user identity, not marketplace user identity) ownership has to be transferred to. After an inquiry about an item, information related to the item can be returned to the potential buyer. For example, a provenance report can be provided in the form of a list of all previous owners and transfers (e.g., as would be obtainable for the five owners of item UID=345 as shown in FIG. 6A). Such a report can include information on the condition of the item at each transfer. Such information would prevent a later seller from advertising an item as mint condition if earlier transfers indicated that the item was no longer in mint condition. Additionally, usage information, such as the number of miles on a car, could be included to prevent an unscrupulous seller from alleging that an item is newer than it is (e.g., by “rolling back” an odometer).

Once the backend server system 150 has authenticated the item, in step 5, the potential buyer (identified by a Buyer ID such as UUID=P888) can contact the seller through the marketplace or directly using app-to-app communication within the app that perform the scanning of the tag. Additional security checks can be performed. For example, the buyer also may check the ad URL contained in the posting, or seller's marketplace user ID. Similarly, the buyer also may check that the item has not been reported lost or stolen.

In an embodiment in which the selling price was fixed, the potential buyer can indicate that the item will be purchased on condition that the item is again proven to be in the presence of the owner. In another embodiment, the potential buyer may make a bid that may or may not be accepted by the seller. The buyer also may require that an additional picture is taken of the item to ensure that the condition of the item is still as advertised.

Once a selling price has been agreed upon by the buyer and seller (and optionally the condition of the item confirmed), in step 6, the seller proves that the item is in the presence of the owner by again querying the tag. In one embodiment, the potential buyer includes information to be used in querying the tag and generating resulting authentication information. For example, the app of the potential buyer provides the buyer's UUID (or marketplace id) and generates a random number which are both signed using the shared or private key of the tag. Similarly, the ad URL may be included also to increase the buyer's confidence that she is interacting with the genuine seller. In step 7, the result of the querying of the tag is sent to the app of the potential buyer (optionally with other information such as the seller ID and/or a transaction number identifying the on-going interaction between buyer and seller.).

In step 8, the app of the buyer receives the information generated in step 7 and sends the information to the backend server system 150 for authentication. Once the information is confirmed by the backend server system 150, the potential buyer knows that the item is in the presence of the seller. Alternatively, the app of the buyer also can send the buyer's UUID and random number to the backend server system 150 (e.g., encrypted using a key shared between the app of the buyer and the backend server system 150), and the app of the seller can send the information generated in step 7 directly to the backend server system 150 which then sends a confirmation of the information's authenticity to the buyer.

In step 9, the app of the seller can then automatically inform the backend server system 150 that the seller is releasing ownership of the item pending completion of the sale such that the item cannot be sold a second time. Such a condition can be reflected internal to the backend server system 150 by recording that there is a transaction in progress for the respective item. Such a condition is shown in FIG. 5 (T-in-P=Yes for UID=123). The potential buyer can query the backend server system 150 to ensure that the ownership has been released (but not yet transferred to the buyer) before making payment. In step 10, the buyer can then pay for the item, and the seller can then transfer (e.g., ship or courier) the item to the buyer. In one embodiment, the backend server system 150 acts as an escrow that does not release payment until the item is received by the purchaser.

In step 11, when the item is received by the buyer, the buyer utilizes the buyer's app to scan the item and confirm (by sending the results of the scan to the backend server system 150) that the item is the item agreed to be transferred between the buyer and seller. In step 12, if the item's authenticity is confirmed, the backend server system 150 transfers the ownership to buyer and informs the seller of the change in ownership. Such as change is shown in FIG. 6B with respect to the transaction having Xact_ID=X12345679. In the case of an escrowed payment, the change in ownership likewise releases the payment to the seller.

In an alternative embodiment, the order of steps 9-12 can be altered such that the seller does not release (but not transfer) ownership prior to shipping the item. Instead, upon receipt of the item by the buyer, the scanning and authentication of the item by the buyer automatically indicates to the system that the item has been received, and the seller is contacted to request transfer of ownership. When the seller confirms payment, the seller can transfer ownership to the buyer (by communicating with the backend server system 150), and the buyer is informed that ownership has been transferred.

In addition to the tag-based authentication methods and devices described above, other authentication mechanisms can be used instead of or in addition to the tags described above. For example, RFIDs, barcodes, or QR-codes can be used for item identification and/or authentication. Similarly, watermarking with automatic verification in the backend can be used for authentication. For example, a watermark with a unique identifier can be applied to the item during manufacturing, and that watermark can be detected by taking a picture of the item. Similarly, a picture of the item can be taken at the time of manufacture or first sale, and the backend server system 150 can utilize computer vision verification for authentication.

In addition to the buyer and seller utilizing the methods and devices described herein to facilitate transfer of rights to an item, additional parties can use the same or similar methods and devices. For example, a shipping company or courier can scan the tag of the item to provide additional information on the item having been shipped in the case of a dispute between buyer and seller. Such scanning can occur at either endpoint of the shipping process or in transit (e.g., at a warehouse).

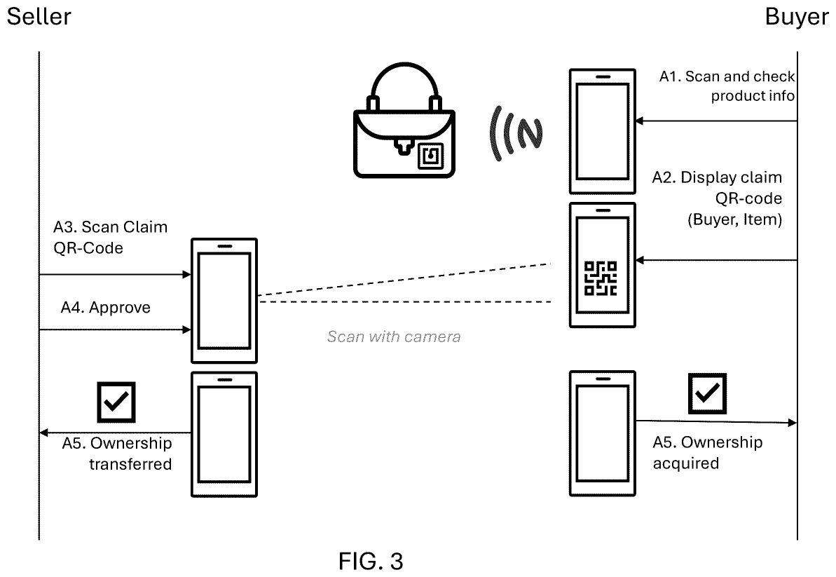

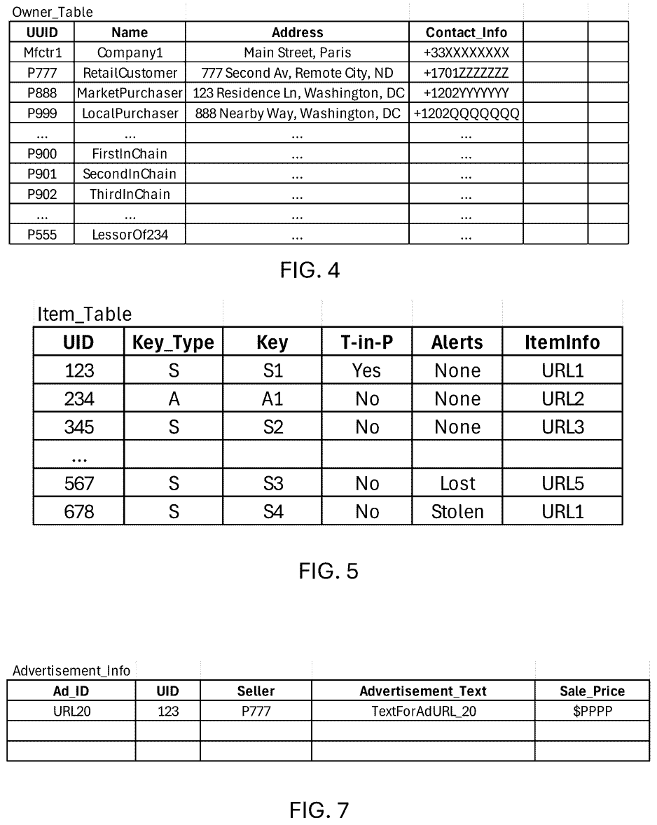

In an alternative embodiment schematically shown in FIG. 3, rather than the buyer and seller being remotely located from each other (as in FIG. 2), the buyer and seller may be co-located which simplifies the shipping issues related to the transfer of the item from seller to buyer. As shown in FIG. 3, a potential buyer (UUID=P999) (e.g., attending a swap meet) may wish to acquire an item (UID=123) that is equipped with a tag as described herein (e.g., that was purchased by the person having UUID=P888 from the original retail customer having UUID=P777). In step A1, the buyer may scan the tag of the item that the buyer wishes to acquire, and the tag of the item generates authentication information as described above. The app of the buyer contacts the backend server system 150 to verify the authentication information, and, if verified, the app of the buyer identifies the item as authentic. The app of the buyer then generates a QR code that can be used to claim the item (i.e., indicates that the item is being transferred), and the QR code is displayed on the screen of the computing device (e.g., mobile phone) of the buyer (UUID=P999) via the buyer's app. In step A3, the seller of the item (UUID=888) then scans the QR code generated on the app of the buyer, and in step A4, the transfer to the buyer is approved. Such an approval may occur after money is transferred either physically or electronically between the buyer and seller. In step A5, the backend server system 150 confirms the change of ownership to both the buyer and the seller. FIG. 6C shows a result of the transfer in the transaction have Xact_ID=X12345680.

In an alternative embodiment of step A2 and A3, rather than the buyer generating a QR code, the backend server system 150 sends a push notification to the app of the seller given that the seller is registered with the backend server system 150 as the current owner. The seller can then approve the sale in step A4 as discussed above.

The methods and systems described herein can be implemented in a number of technologies but generally relate to systems, devices, and processing circuitry for performing the processes described herein. In one embodiment, the processing circuitry (e.g., the controller and controller circuitry) is implemented as one of or as a combination of: an application specific integrated circuit (ASIC), a field programmable gate array (FPGA), a generic array of logic (GAL), a programmable array of logic (PAL), circuitry for allowing one-time programmability of logic gates (e.g., using fuses) or reprogrammable logic gates. Furthermore, the processing circuitry can include a computer processor and having embedded and/or external non-volatile computer readable memory (e.g., RAM, SRAM, FRAM, PROM, EPROM, and/or EEPROM) that stores computer instructions (binary executable instructions and/or interpreted computer instructions) for controlling the computer processor to perform the processes described herein. The computer processor circuitry may implement a single processor or multiprocessors, each supporting a single thread or multiple threads and each having a single core or multiple cores.

A computer program product further includes at least one non-transitory computer readable medium (e.g., an optical disc, a magnetic disk, or a non-volatile memory device such as a flash or NAND memory) having instructions stored thereon for controlling a processor to perform at least one method as described herein.

Additional embodiments are provided below.
(1) A method of transferring an item from a seller to a buyer, the method including, but not limited to: receiving, from the seller, a first notification of the item to be transferred, wherein the first notification includes a unique identifier of the item and a first value generated by a tag physically associated with the item to be transferred; receiving, based on the first notification, a request to transfer the item to a buyer; receiving, based on the request to transfer, a second value generated by the tag associated with the item to be transferred; receiving a second notification that the buyer has authorized payment for transfer of the item; receiving, from the buyer, a third notification, generated by the tag, that the buyer has received the item; and transferring to the buyer, based on the third notification, a right to the item.
(2) The method according to (1), further including, but not limited to: receiving, prior to receiving the first notification, a fourth notification associating the right to the item with the seller.
(3) The method according to either one of (1) and (2), further including, but not limited to: receiving, from a manufacturer of the item, an authentication credential for the item corresponding to the unique identifier.
(4) The method according to (3), wherein the authentication credential is received prior to receiving the first notification.
(5) The method according to either one of (3) and (4), wherein the first value is a message authentication code based on the authentication credential.
(6) The method according to any one of (3)-(5), wherein the authentication credential is a shared key uniquely associated with the unique identifier.
(7) The method according to any one of (3)-(5), wherein the authentication credential is a public key associated with the unique identifier.
(8) A method of transferring an item from a seller to a buyer, the method including, but not limited to: receiving a first notification from the item to be transferred, wherein the first notification includes a unique identifier of the item and a value generated by a tag associated with the item to be transferred; verifying, using a remote server, that the first notification indicates that the item is authentic; receiving an indication from the seller that the seller intends to transfer the item to the buyer; and updating, at the remote server, that the item has been transferred to the buyer.
(9) The method according to (8), wherein verifying, using the remote server, that the first notification indicates that the item is authentic includes, but is not limited to: generating, by the remote server, a QR code indicating that the seller is transferring the item to the buyer; displaying the QR code on a first computing device of the buyer; scanning the QR on a second computing device of the seller; and authorizing on the second computing device the transfer of the item to the buyer.
(10) The method according to (8), wherein verifying, using the remote server, that the first notification indicates that the item is authentic includes, but is not limited to: sending, by the remote server, a transfer message to a computing device of the seller; and receiving from the computing device a message authorizing transfer of the item to the buyer.
(11) The method according to any one of (8)-(10), further including, but not limited to: receiving, prior to receiving the first notification, a second notification associating the item with the seller.
(12) The method according to any one of (8)-(11), further including, but not limited to: receiving, from a manufacturer of the item, an authentication credential for the item corresponding to the unique identifier.
(13) The method according to (12), wherein the authentication credential is received prior to receiving the first notification.
(14) The method according to either one of (12) and (13), wherein the value is a message authentication code based on the authentication credential.
(15) The method according to any one of (12)-(14), wherein the authentication credential is a shared key uniquely associated with the unique identifier.
(16) The method according to either one of (12) and (13), wherein the authentication credential is a public key associated with the unique identifier.
(17) A device for transferring an item from a seller to a buyer, the device including, but not limited to: processing circuitry for performing the method of any one of (1)-(7).
(18) A device for transferring an item from a seller to a buyer, the device including, but not limited to: processing circuitry for performing the method of any one of (8)-(16).
(19) A computer program product for transferring an item from a seller to a buyer including, but not limited to: a non-volatile computer readable medium including embedded therein computer instructions for controlling a processor to perform the method of: any one of (1)-(7).
(20) A computer program product for transferring an item from a seller to a buyer including, but not limited to: a non-volatile computer readable medium including embedded therein computer instructions for controlling a processor to perform the method of: any one of (8)-(16).

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting, of the scope of the disclosure, as well as other claims. The disclosure, including any readily discernible variants of the teachings herein, defines, in part, the scope of the foregoing claim terminology such that no inventive subject matter is dedicated to the public.

1. A method of transferring an item from a seller to a buyer, the method comprising:
receiving, from the seller, a first notification of the item to be transferred, wherein the first notification includes a unique identifier of the item and a first value generated by a tag physically associated with the item to be transferred;
receiving, based on the first notification, a request to transfer the item to a buyer;
receiving, based on the request to transfer, a second value generated by the tag associated with the item to be transferred;
receiving a second notification that the buyer has authorized payment for transfer of the item;
receiving, from the buyer, a third notification, generated by the tag, that the buyer has received the item; and
transferring to the buyer, based on the third notification, a right to the item.

2. The method as claimed in claim 1, further comprising:
receiving, prior to receiving the first notification, a fourth notification associating the right to the item with the seller.

3. The method as claimed in claim 1, further comprising:
receiving, from a manufacturer of the item, an authentication credential for the item corresponding to the unique identifier.

4. The method as claimed in claim 3, wherein the authentication credential is received prior to receiving the first notification.

5. The method as claimed in claim 3, wherein the first value is a message authentication code based on the authentication credential.

6. The method as claimed in claim 3, wherein the authentication credential is a shared key uniquely associated with the unique identifier.

7. The method as claimed in claim 3, wherein the authentication credential is a public key associated with the unique identifier.

8. A method of transferring an item from a seller to a buyer, the method comprising:
receiving a first notification from the item to be transferred, wherein the first notification includes a unique identifier of the item and a value generated by a tag associated with the item to be transferred;
verifying, using a remote server, that the first notification indicates that the item is authentic;
receiving an indication from the seller that the seller intends to transfer the item to the buyer; and
updating, at the remote server, that the item has been transferred to the buyer.

9. The method as claimed in claim 8, wherein verifying, using the remote server, that the first notification indicates that the item is authentic comprises:
generating, by the remote server, a QR code indicating that the seller is transferring the item to the buyer;
displaying the QR code on a first computing device of the buyer;
scanning the QR on a second computing device of the seller; and
authorizing on the second computing device the transfer of the item to the buyer.

10. The method as claimed in claim 8, wherein verifying, using the remote server, that the first notification indicates that the item is authentic comprises:
sending, by the remote server, a transfer message to a computing device of the seller; and
receiving from the computing device a message authorizing transfer of the item to the buyer.

11. The method as claimed in claim 8, further comprising:
receiving, prior to receiving the first notification, a second notification associating the item with the seller.

12. The method as claimed in claim 8, further comprising:
receiving, from a manufacturer of the item, an authentication credential for the item corresponding to the unique identifier.

13. The method as claimed in claim 12, wherein the authentication credential is received prior to receiving the first notification.

14. The method as claimed in claim 12, wherein the value is a message authentication code based on the authentication credential.

15. The method as claimed in claim 12, wherein the authentication credential is a shared key uniquely associated with the unique identifier.

16. The method as claimed in claim 12, wherein the authentication credential is a public key associated with the unique identifier.

17. A device for transferring an item from a seller to a buyer, the device comprising:
processing circuitry for performing the method of:
receiving, from the seller, a first notification of the item to be transferred, wherein the first notification includes a unique identifier of the item and a first value generated by a tag physically associated with the item to be transferred;
receiving, based on the first notification, a request to transfer the item to a buyer;
receiving, based on the request to transfer, a second value generated by the tag associated with the item to be transferred;
receiving a second notification that the buyer has authorized payment for transfer of the item;
receiving, from the buyer, a third notification, generated by the tag, that the buyer has received the item; and
transferring to the buyer, based on the third notification, a right to the item.

18. A device for transferring an item from a seller to a buyer, the device comprising:
processing circuitry for performing the method of:
receiving a first notification from the item to be transferred, wherein the first notification includes a unique identifier of the item and a value generated by a tag associated with the item to be transferred;
verifying, using a remote server, that the first notification indicates that the item is authentic;
receiving an indication from the seller that the seller intends to transfer the item to the buyer; and
updating, at the remote server, that the item has been transferred to the buyer.

19. A computer program product for transferring an item from a seller to a buyer comprising:
a non-volatile computer readable medium including embedded therein computer instructions for controlling a processor to perform the method of:
receiving, from the seller, a first notification of the item to be transferred, wherein the first notification includes a unique identifier of the item and a first value generated by a tag physically associated with the item to be transferred;
receiving, based on the first notification, a request to transfer the item to a buyer;
receiving, based on the request to transfer, a second value generated by the tag associated with the item to be transferred;
receiving a second notification that the buyer has authorized payment for transfer of the item;
receiving, from the buyer, a third notification, generated by the tag, that the buyer has received the item; and
transferring to the buyer, based on the third notification, a right to the item.

20. A computer program product for transferring an item from a seller to a buyer comprising:
a non-volatile computer readable medium including embedded therein computer instructions for controlling a processor to perform the method of:
receiving a first notification from the item to be transferred, wherein the first notification includes a unique identifier of the item and a value generated by a tag associated with the item to be transferred;
verifying, using a remote server, that the first notification indicates that the item is authentic;
receiving an indication from the seller that the seller intends to transfer the item to the buyer; and
updating, at the remote server, that the item has been transferred to the buyer.
